(19) United States
(12) Patent Application Publication
(10) Pub. No.: US 2017/0212246 A1
(43) Pub. Date: Jul. 27, 2017

(54) RECEIVING APPARATUS, RECEIVING METHOD, AND PROGRAM FOR GLOBAL NAVIGATION SATELLITE SYSTEM

(71) Applicant: Sony Semiconductor Solutions Corporation, Kanagawa (JP)

(72) Inventors: Suguru Houchi, Kanagawa (JP); Yutaka Ichimura, Kanagawa (JP); Hiroshi Kawashima, Kanagawa (JP)

(73) Assignee: Sony Semiconductor Solutions Corporation, Kanagawa (JP)

(21) Appl. No.: 15/500,296

(22) PCT Filed: Aug. 11, 2015
(86) PCT No.: PCT/JP2015/072720

§ 371 Date: Jan. 30, 2017

(30) Foreign Application Priority Data
Aug. 20, 2014 (JP) 2014-167496

(51) Int. Cl. G01S 19/30; G01S 19/33

(52) U.S. Cl. CPC G01S 19/30; G01S 19/33

(57) ABSTRACT

The present technology relates to a receiving apparatus, a receiving method, and a program for a global navigation satellite system that enable the reception of various satellite signals with an inexpensive configuration.

By using memories 173-2 and 174-2 for 1024 words included in a signal capturing tool 101-2 for receiving a GPS satellite signal in addition to memories 173-1 and 174-1 for 1024 words included in a signal capturing tool 101-1 for receiving the GPS satellite signal, a frequency domain correlation unit 124′ calculates a correlation in a frequency domain through FFT calculation relative to a pseudo signal generated from a spreading code of a BeiDou satellite signal with 2048 words. Accordingly, when signal capturing tools 101 that receive a GPS satellite signal are simply combined with one another in a plurality of manners, various satellite signals can be received. The present technology can be applied to a GNSS receiver.

### TECHNICAL FIELD

The present technology relates to a receiving apparatus, a receiving method, and a program for a global navigation satellite system, in particular, a receiving apparatus, a receiving method, and a program for the global navigation satellite system that have been configured to be capable of receiving satellite signals by spreading codes having a plurality of code lengths with an inexpensive hardware configuration.

### BACKGROUND ART

A technology using a global navigation satellite system called a global navigation satellite system(s) (GNSS(s)) is in widespread use.

This GNSS acquires position information on the earth (latitude and longitude) by communicating with a plurality of artificial satellites which orbits around the earth and, for example, is applied to a car navigation system.

This GNSS has a plurality of classes depending on regions, of which the operating principles are substantially the same, and examples thereof include a global positioning system (GPS, hereinafter, also referred to simply as GPS) managed by the United States (see Non-Patent Document 1), a BeiDou navigation satellite system (hereinafter, assumed to be also referred to simply as BeiDou) independently developed by the People's Republic of China, and a global navigation satellite system (Galileo) (hereinafter, also referred to simply as Galileo) mainly developed by the European Communities.

### CITATION LIST

### Non-Patent Document

Non-Patent Document 1: GLOBAL POSITIONING SYSTEM STANDARD POSITIONING SERVICE SIGNAL SPECIFICATION

### SUMMARY OF THE INVENTION

### Problems to be Solved by the Invention

Incidentally, upon receiving a signal from a satellite and capturing the received signal, a receiving apparatus of the GNSS described above needs to carry out fast Fourier transform (FFT) processing on a spreading code included in the signal. Therefore, the receiving apparatus (receiver) of the GNSS includes a processor to process the FFT and a memory required for the processing in a signal capturing unit.

However, the code length of the spreading code is different depending on the classes of the GNSS. For example, GPS has 1024 points (the number of words), BeiDou has 2048 points, and Galileo has 4096 points. Besides, the processors and the memories required in the processing for the respective classes differ from one another.

For this reason, in order to configure a receiving apparatus compatible with the three types of the classes of the GNSS, it is necessary to dispose a processor and a memory for the FFT compatible with the number of points of each of the extension codes, which causes an increase in apparatus cost as a result.

The present technology has been made in view of such a situation and, particularly, an object thereof is to achieve a GNSS receiving apparatus compatible with extension codes having a plurality of types of code lengths with an inexpensive and simple hardware configuration.

### Solutions to Problems

A receiving apparatus for a global navigation satellite system according to an aspect of the present technology includes a reception unit that receives a satellite signal, a correlation calculation unit that calculates a correlation between the satellite signal and a pseudo signal through FFT calculation regarding the satellite signal received by the reception unit and the pseudo signal generated from a spreading code having a data length corresponding to a class of the satellite signal, a memory for a predetermined data length required for the FFT calculation in the correlation calculation unit, and a plurality of signal capturing tools that captures the satellite signal on the basis of the correlation calculated by the correlation calculation unit, in which the correlation calculation unit of the predetermined signal capturing tool carries out the FFT calculation on the satellite signal and the pseudo signal generated from the spreading code having the data length corresponding to the class of the satellite signal by using the memory of its own and memories of other signal capturing tools in accordance with the class of the satellite signal and calculates the correlation between the satellite signal and the pseudo signal.

The correlation calculation unit can be caused to calculate the correlation between the satellite signal and the pseudo signal in a frequency domain or a time domain.

The predetermined data length can be set to 1024 words, and, when the class of the satellite signal is a satellite signal from a global positioning system (GPS) satellite, the correlation calculation unit can be caused to carry out the FFT calculation on the satellite signal and the pseudo signal generated from the spreading code having the data length corresponding to the class of the satellite signal by using only the memory of its own and calculate the correlation between the satellite signal and the pseudo signal.

The correlation calculation unit can be configured to include a radix-4 calculation unit that carries out radix-4 FFT calculation on 1024 words, and the radix-4 calculation unit can be caused to calculate the correlation between the satellite signal and the pseudo signal by repeatedly carrying out the radix-4 FFT calculation on 1024 words five times.

The predetermined data length can be set to 1024 words, and, when the class of the satellite signal is a satellite signal from a BeiDou navigation satellite system (BeiDou) satellite, the correlation calculation unit can be caused to carry out the FFT calculation on the satellite signal and the pseudo signal generated from the spreading code having the data length according to the class of the satellite signal by using the memory of its own and a memory of one of the aforementioned other signal capturing tools and calculate the correlation between the satellite signal and the pseudo signal.

The correlation calculation unit can be configured to include a radix-4 calculation unit that carries out radix-4 FFT calculation on 1024 words and a radix-2 calculation unit that carries out radix-2 FFT calculation on 2048 words and can be caused to calculate the correlation between the satellite signal and the pseudo signal by causing each of the radix-4 calculation unit of its own and radix-4 calculation units of the aforementioned other signal capturing tools to repeat the radix-4 FFT calculation on 1024 words five times and thereafter, carrying out the radix-2 FFT calculation on 2048 words.

The predetermined data length can be set to 1024 words, and, when the class of the satellite signal is a satellite signal from a Galileo satellite, the correlation calculation unit can be caused to carry out the FFT calculation on the satellite signal and the pseudo signal generated from the spreading code having the data length corresponding to the class of the satellite signal by using the memory of its own and memories of three of the aforementioned other signal capturing tools and calculate the correlation between the satellite signal and the pseudo signal.

At least one of the following actions is carried out among the plurality of signal capturing tools: one of the signal capturing tools captures the satellite signal from a global positioning system (GPS) satellite by itself, any two of the signal capturing tools capture the satellite signal from a BeiDou navigation satellite system (BeiDou) satellite, and any four of the signal capturing tools capture the satellite signal from a Galileo satellite.

A receiving method of a receiving apparatus for a global navigation satellite system according to an aspect of the present technology is a receiving method for a receiving apparatus for the global navigation satellite system including a reception unit that receives a satellite signal, a correlation calculation unit that calculates a correlation between the satellite signal and a pseudo signal through FFT calculation regarding the satellite signal received by the reception unit and the pseudo signal generated from a spreading code having a data length corresponding to a class of the satellite signal, a memory for a predetermined data length required for the FFT calculation in the correlation calculation unit, and a plurality of signal capturing tools that captures the satellite signal on the basis of the correlation calculated by the correlation calculation unit, in which the correlation calculation unit of the predetermined signal capturing tool carries out the FFT calculation on the satellite signal and the pseudo signal generated from the spreading code having the data length corresponding to the class of the satellite signal by using the memory of its own and memories of other signal capturing tools in accordance with the class of the satellite signal and calculates the correlation between the satellite signal and the pseudo signal.

A program according to an aspect of the present technology causes a computer that controls a receiving apparatus including a reception unit that receives a satellite signal, a correlation calculation unit that calculates a correlation between the satellite signal and a pseudo signal through FFT calculation regarding the satellite signal received by the reception unit and the pseudo signal generated from a spreading code having a data length corresponding to a class of the satellite signal, a memory for a predetermined data length required for the FFT calculation in the correlation calculation unit, and a plurality of signal capturing tools that captures the satellite signal on the basis of the correlation calculated by the correlation calculation unit, to execute such that: the correlation calculation unit of the predetermined signal capturing tool carries out the FFT calculation on the satellite signal and the pseudo signal generated from the spreading code having the data length corresponding to the class of the satellite signal by using the memory of its own and memories of other signal capturing tools in accordance with the class of the satellite signal and calculates the correlation between the satellite signal and the pseudo signal.

In an aspect of the present technology, the satellite signal is received by the reception unit, the correlation between the satellite signal and the pseudo signal is calculated by the correlation calculation unit through the FFT calculation regarding the satellite signal received by the reception unit and the pseudo signal generated from the spreading code having the data length corresponding to the class of the satellite signal, and the memory for the predetermined data length required for the FFT calculation in the correlation calculation unit and a plurality of signal capturing tools that captures the satellite signal on the basis of the correlation calculated by the correlation calculation unit are disposed. Additionally, the FFT calculation on the satellite signal and the pseudo signal generated from the spreading code having the data length corresponding to the class of the satellite signal is carried out by the correlation calculation unit of the predetermined signal capturing tool using the memory of its own and memories of other signal capturing tools in accordance with the class of the satellite signal and then, a correlation between the satellite signal and the pseudo signal is calculated.

The receiving apparatus for the global navigation satellite system according to an aspect of the present technology may be an independent apparatus or may be a block that carries out reception processing.

### Effects of the Invention

According to an aspect of the present technology, it is made possible to receive a variety of satellite signals simply with a plurality of configurations for receiving a predetermined satellite signal.

### BRIEF DESCRIPTION OF DRAWINGS

FIG. 1 is a diagram illustrating a configuration example of a GNSS receiver to which the present technology is applied according to an embodiment.

FIG. 2 is a diagram for explaining a configuration example of a signal capturing unit in FIG. 1.

FIG. 3 is a diagram for explaining a function implemented by a synchronous addition unit in FIG. 2.

FIG. 4 is a diagram for explaining a function implemented by a frequency domain correlation unit in FIG. 2.

FIG. 5 is a diagram for explaining a function implemented by an absolute-value adding unit in FIG. 2.

FIG. 6 is a flowchart for explaining signal capturing processing by the signal capturing unit in FIG. 2.

FIG. 7 is a diagram for explaining processing of calculating a correlation for capturing a GPS satellite signal.

FIG. 8 is a diagram for explaining radix-4 butterfly calculation and radix-2 butterfly calculation.

FIG. 9 is a diagram for explaining operation of capturing a BeiDou satellite signal by the signal capturing unit.

FIG. 10 is a diagram for explaining processing of calculating a correlation for capturing a BeiDou satellite signal.

FIG. 11 is a diagram for explaining the processing of calculating the correlation for capturing the BeiDou satellite signal.

FIG. 12 is a diagram for explaining operation of capturing a Galileo satellite signal by the signal capturing unit.

FIG. 13 is a diagram illustrating a configuration example of a typical signal capturing unit for capturing the plurality of satellite signals.

FIG. 14 is a diagram for explaining variations for receiving the plurality of satellite signals using the plurality of signal capturing tools.

FIG. 15 is a diagram for explaining a configuration example of a general-purpose personal computer.

### MODE FOR CARRYING OUT THE INVENTION

<Configuration Example of Receiver (Receiving Apparatus) of GNSS System to which Present Technology is Applied>

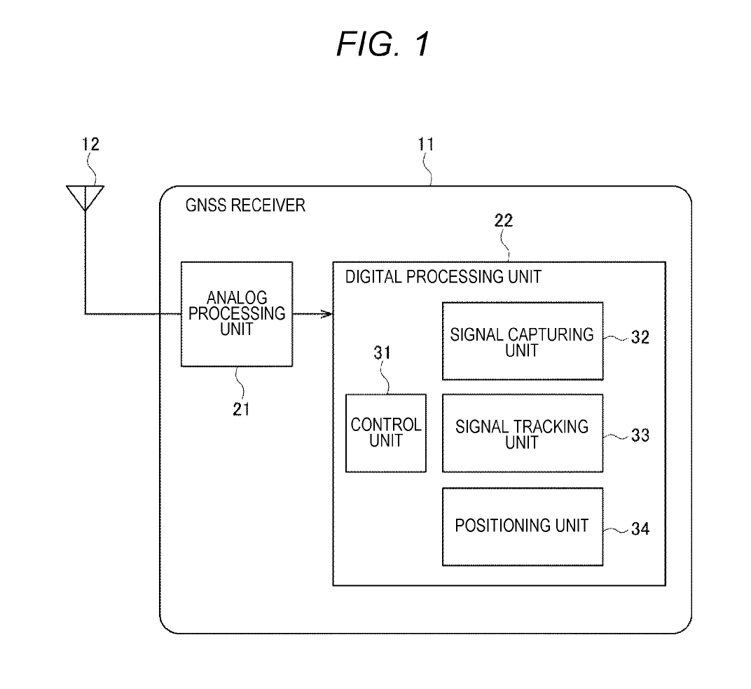

FIG. 1 illustrates a configuration example of a global navigation satellite system(s) (GNSS(s)) receiver according to an embodiment, to which the present technology is applied. A GNSS receiver 11 in FIG. 1 distinguishes satellite signals from a global positioning system (GPS) satellite, a BeiDou navigation satellite system (BeiDou) satellite, and a Galileo satellite (not illustrated) from one another to receive and then works out position information.

Here, the GPS satellite is a satellite used in a global positioning system (GPS, hereinafter, simply referred to as GPS) managed by the United States.

Meanwhile, the BeiDou satellite is a satellite used in a BeiDou navigation satellite system independently developed by the People's Republic of China. In addition, the Galileo satellite is a satellite used by a global navigation satellite system (Galileo) mainly developed by the European Communities.

Describing in more detail, the GNSS receiver 11 includes an analog processing unit 21 and a digital processing unit 22.

The analog processing unit 21 converts the satellite signal received via an antenna 12 into a digital signal to supply to the digital processing unit 22.

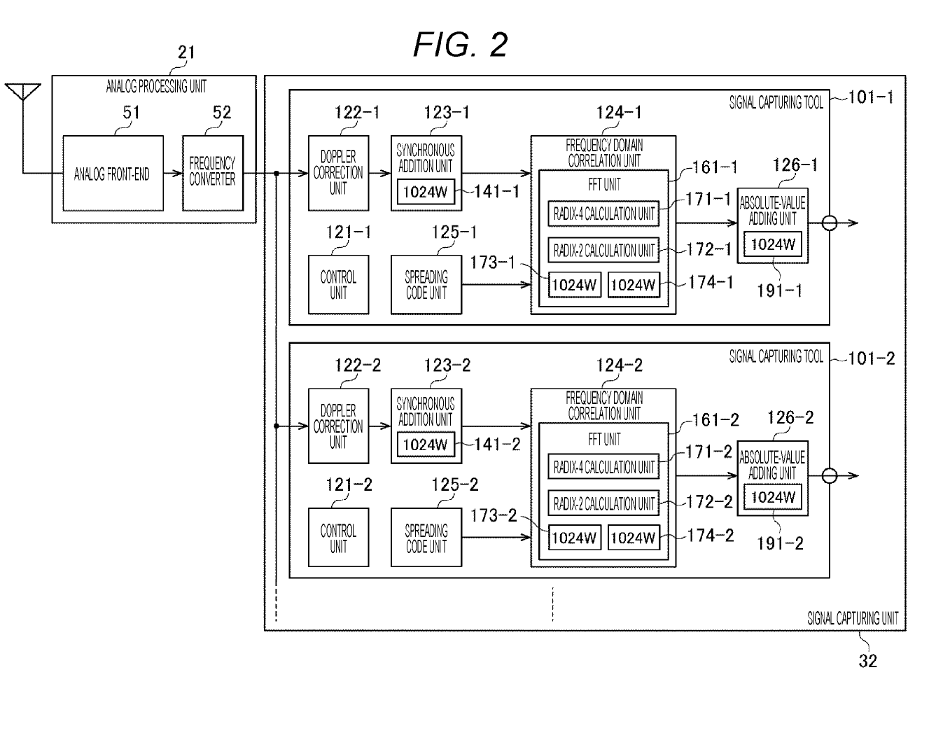

Describing in more detail, the analog processing unit 21 includes an analog front-end 51 (FIG. 2) to down-convert a radio frequency (RF) signal received via the antenna 12 into intermediate frequency (IF). The analog processing unit 21 further includes a frequency converter 52 (FIG. 2) to carry out analog-digital (AD) conversion on the satellite signal constituted by an analog signal, thereby converting an IF signal constituted by the analog signal to baseband to sample, while quantizing the IF signal to output as the digital signal.

The digital processing unit 22 analyzes the satellite signal converted into the digital signal and then specifies the position of its own.

Describing in more detail, the digital processing unit 22 includes a control unit 31, a signal capturing unit 32, a signal tracking unit 33, and a positioning unit 34. The control unit 31 is constituted by a central processing unit (CPU), a random access memory (RAM), a read only memory (ROM), and the like and controls the entire operation of the digital processing unit 22.

The signal capturing unit 32 captures the satellite signal on the basis of a correlation between a spreading code unique to each of the satellite signals after being converted into the digital signal and a spreading code unique to the GNSS receiver 11 and then supplies a parameter necessary for the capturing to the signal tracking unit 33 and the positioning unit 34.

The signal tracking unit 33 uses the parameter supplied from the signal capturing unit 32 to maintain a state of the satellite signal being captured through the tracking and then supplies the sequentially captured satellite signals to the positioning unit 34.

The positioning unit 34 obtains a distance up to an artificial satellite within the actual time on the basis of the satellite signal supplied from the signal capturing unit 32, thereby working out the current position of its own from positional relationships relative to the plurality of artificial satellites whose positions are known.

<Configuration Example of Signal Capturing Unit>

Next, a configuration example of the signal capturing unit 32 in FIG. 1 will be described with reference to FIG. 2.

The signal capturing unit 32 is made up of a plurality of signal capturing tools 101-1 to 101-n. Note that, although FIG. 1 only depicts the signal capturing tools 101-1 and 101-2, it is possible to configure n number of the signal capturing tools as long as the arrangement thereof is physically possible. In addition, when there is no particular need to distinguish the signal capturing tools 101-1 to 101-n from one another, the signal capturing tools 101-1 to 101-n will be referred to simply as signal capturing tools 101. Other configurations will be also referred to in a similar manner. Meanwhile, signals captured by the signal capturing tools 101-1 to 101-n will be referred to as first to n-th channel signals, respectively.

The signal capturing tools 101 (101-1 to 101-n) include control units 121 (121-1 to 121-n), Doppler correction units 122 (122-1 to 122-n), synchronous addition units 123 (123-1 to 123-n), frequency domain correlation units 124 (124-1 to 124-n), spreading code units 125 (125-1 to 125-n), and absolute-value adding units 126 (126-1 to 126-n).

The control unit 121 controls the entire operation of the signal capturing tool 101. Furthermore, while the plurality of signal capturing tools 101 is caused to operate in cooperation with one another upon receiving the satellite signal from each of the GPS satellite, the BeiDou satellite, and the Galileo satellite, the control unit 121 controls a master operating independently and a slave operating subordinately through the communication among the control units 121 of the signal capturing tools 101.

The Doppler correction unit 122 corrects a frequency shift caused by a Doppler effect of the satellite signal.

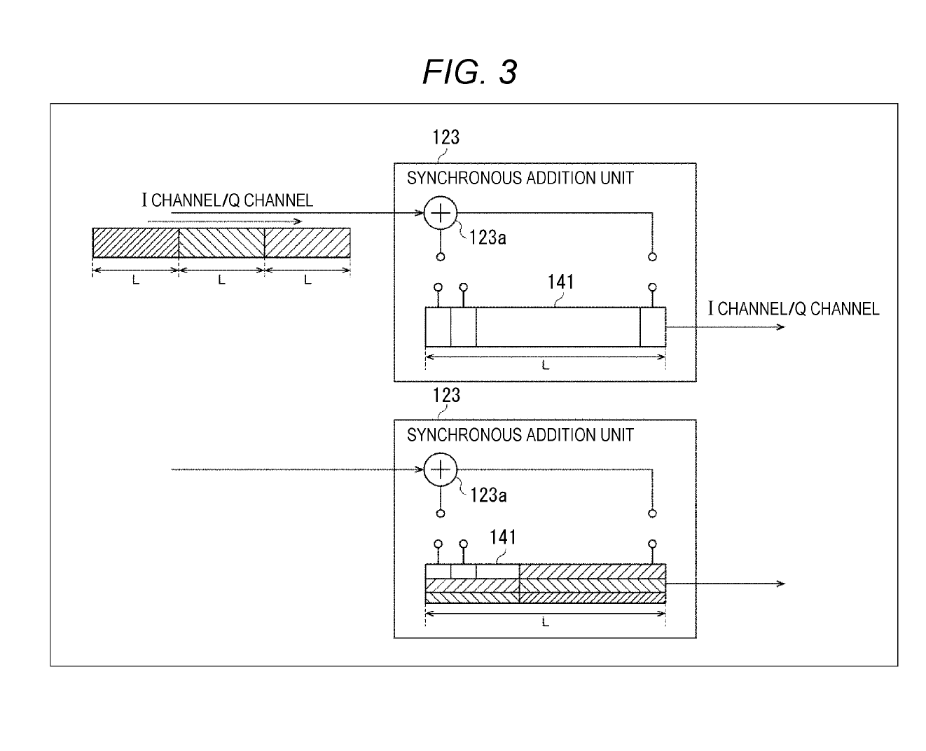

The synchronous addition unit 123 synchronously adds data having a data length of 1024 points (the number of words is 1024: 1024 W) to each of an I channel and a Q channel, which data length corresponds to a spreading code length of the GPS satellite equivalent to one millisecond. Describing in more detail, each of the synchronous addition units 123 includes a memory 141 (141-1 to 141-n) for storage and carries out the synchronous addition on each of the I channel and the Q channel to enhance a signal-noise (SN) ratio before the output to the frequency domain correlation unit 124. Note that a detailed function of the synchronous addition unit 123 will be described later with reference to FIG. 3.

The frequency domain correlation unit 124 obtains a correlation between the received satellite signal and a pseudo signal generated from a unique spreading code of its own supplied from the spreading code unit 125 through fast Fourier transform (FFT) and then works out a transmission delay time having a highest correlation.

Describing in more detail, the frequency domain correlation units 124 (124-1 to 124-n) include FFT units 161 (161-1 to 161-n), respectively. The FFT units 161 (161-1 to 161-n) include radix-4 calculation units 171 (171-1 to 171-n), radix-2 calculation units 172 (172-1 to 172-n), and memories 173 and 174 (173-1 to 173-n and 174-1 to 174-n), respectively.

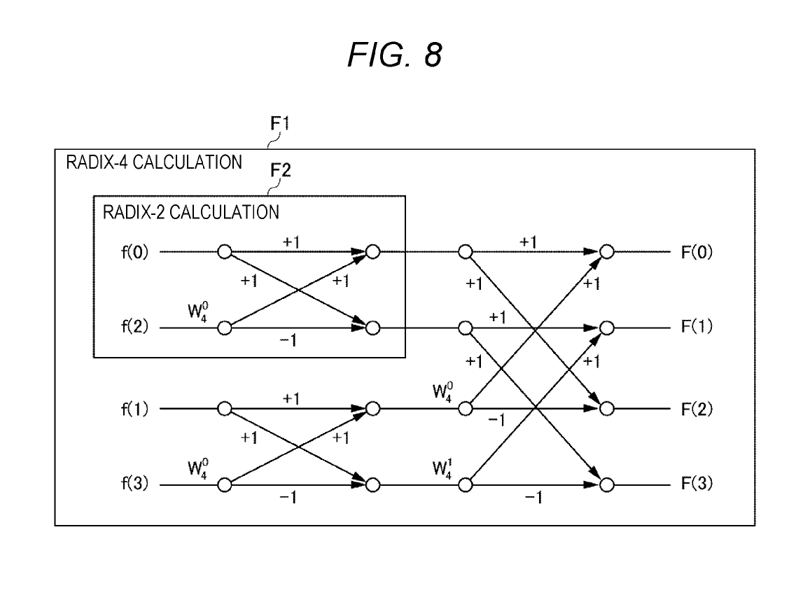

The radix-4 calculation unit 171 carries out the FFT on an input signal with 1024 points when the radix is set to 4, which will be described later with reference to FIG. 8.

The radix-2 calculation unit 172 carries out the FFT on the input signal with 1024 points when the radix is set to 2, which will be described later with reference to FIG. 8.

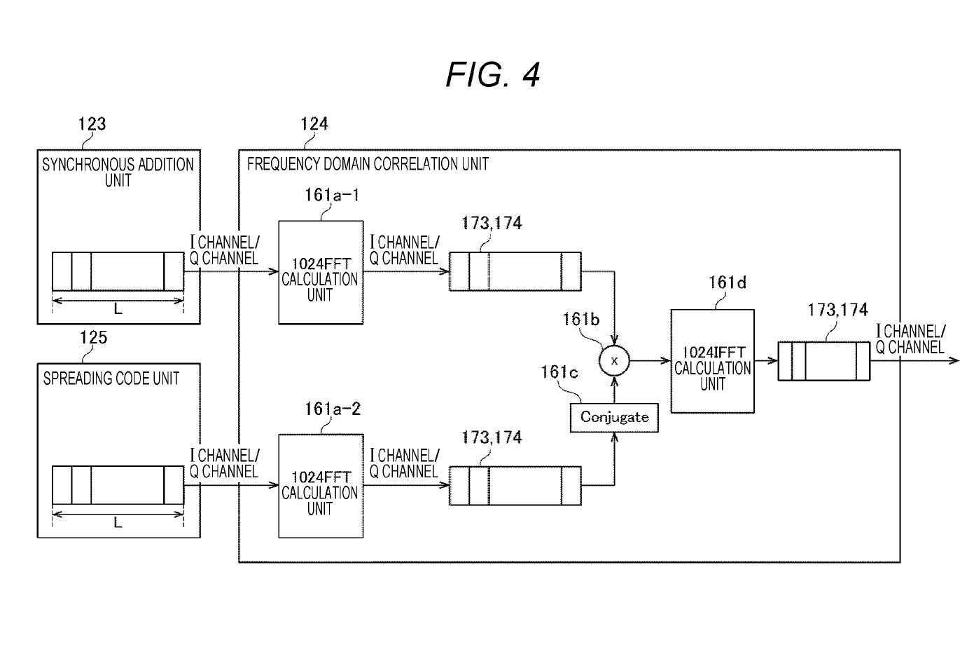

The memories 173 and 174 are, for example, memories for data having a data length of 1024 points (the number of words is 1024) and temporarily store calculation results and the like used in the calculation in the radix-4 calculation unit 171 and radix-2 calculation unit 172. Note that details of the function of the frequency domain correlation unit 124 will be described later with reference to FIG. 4.

The spreading code unit 125 stores unique spreading codes included in the GNSS receiver 11 to supply to the frequency domain correlation unit 124. Describing in more detail, the spreading code unit 125 stores each of a unique spreading code with 1024 points for the GPS satellite, a unique spreading code with 2048 points for the BeiDou satellite, and a unique spreading code with 4096 points for the Galileo satellite included in the GNSS receiver 11 to output by switching depending on which mode is used from among modes of receiving the satellite signals for the GPS satellite, the BeiDou satellite, and the Galileo satellite.

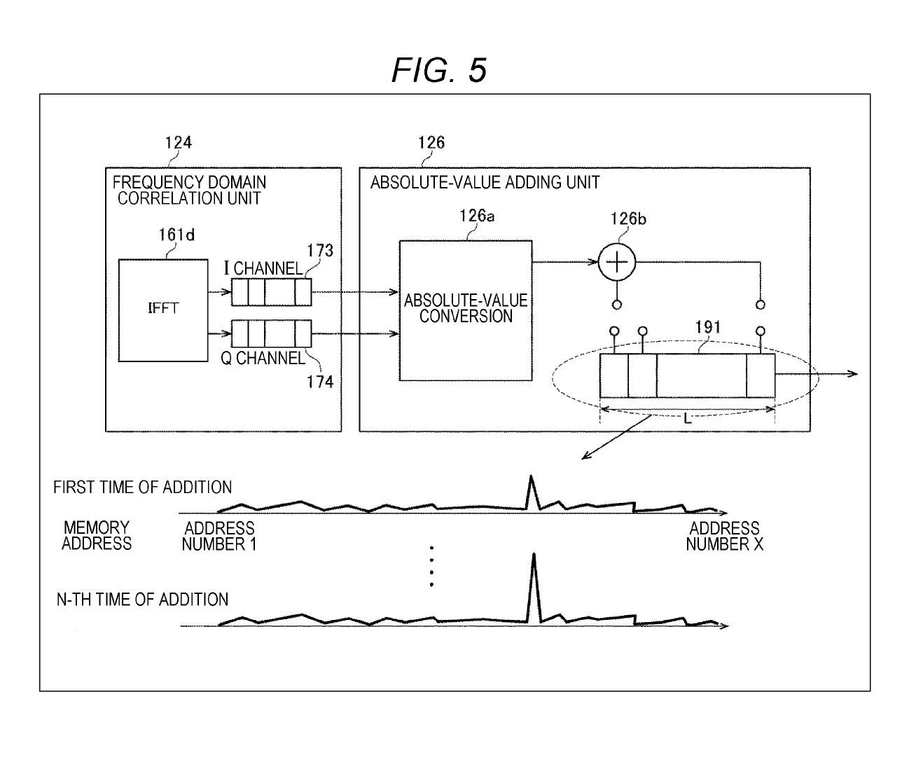

Each of the absolute-value adding units 126 (126-1 to 126-n) converts each of the I channel and the Q channel into an absolute value by adding a calculation result output from the frequency domain correlation unit 124. The absolute-value adding units 126 include, for example, memories 191 (191-1 to 191-n) each for 1024 points to use in the calculation at this time as necessary. Note that details of the function of the absolute-value adding unit 126 will be described later with reference to FIG. 5.

Meanwhile, all of the memories 141, 173, 174, and 191 will be assumed here as being for 1024 points (1024 W: the number of words is 1024) in this description. This figure of 1024 points is derived from the spreading code of the GPS satellite having 1024 points. Accordingly, the signal capturing tool 101 in FIG. 2 is capable of capturing the satellite signal from the GPS satellite alone. However, the spreading code of the BeiDou satellite has 2048 points, whereas the spreading code of the Galileo satellite has 4096 points. Thus, the signal capturing tool 101 is not capable of capturing either satellite signal alone.

Incidentally, the spreading code of the BeiDou satellite has two times the number of points of the spreading code of the GPS satellite and additionally, the spreading code of the Galileo satellite has four times the number of points of the spreading code of the GPS satellite.

By taking advantage of this, in the signal capturing unit 32, one of the signal capturing tools 101-1 and 101-2 shares the memories 141-1, 141-2, 173-1, 173-2, 174-1, 174-2, 191-1, and 191-2 and the radix-4 calculation units 171-1 and 171-2 in order to cope with the spreading code of the BeiDou satellite with 2048 points. Accordingly, for example, when the signal capturing tool 101-1 serves as the master, whereas the signal capturing tool 101-2 serves as the slave, the control unit 121-1 of the signal capturing tool 101-1 carries out such operation as declaring itself as the master, while instructing the control unit 121-2 of the signal capturing tool 101-2 to serve as the slave.

At this time, the control unit 121-2 of the signal capturing tool 101-2 serves as the slave and thus, stops the operation of the Doppler correction unit 122-2, the synchronous addition unit 123-2, the frequency domain correlation unit 124-2, the spreading code unit 125-2, and the absolute-value adding unit 126-2.

Furthermore, the control unit 121-2 controls such that the memory 141-2 is put under the direction of the synchronous addition unit 123-1 of the signal capturing tool 101-1. The control unit 121-2 also controls such that the memories 173-2 and 174-2 and the radix-4 calculation unit 171-2 are put under the control of the frequency domain correlation unit 124-1. Additionally, the control unit 121-2 controls such that the memory 191-2 is put under the control of the absolute-value adding unit 126-1. Meanwhile, the control unit 121-1 of the signal capturing tool 101-1 controls the spreading code unit 125-1 to cause the spreading code unit 125-1 to output the spreading code with 2048 points for the BeiDou satellite.

With this, the synchronous addition unit 123-1 reserves a storage area for 2048 points constituted by the memories 141-1 and 141-2, thereby processing the spreading code of the BeiDou satellite. In addition, the frequency domain correlation unit 124-1 reserves two storage areas each for 2048 points by using the memories 173-1, 173-2, 174-1, and 174-2 and then controls the two radix-4 calculation units 171-1 and 171-2 for 1024 points and the radix-2 calculation unit 172-1 for 2048 points, thereby being able to process the spreading code of the BeiDou satellite. Furthermore, the absolute-value adding unit 126-1 reserves a storage area for 2048 points constituted by the memories 191-1 and 191-2, thereby being able to process the spreading code of the BeiDou satellite.

Consequently, it is made possible for the signal capturing tool 101-1 to use a storage capacity equal to two times that used during the processing of the spreading code of the GPS satellite, whereby the processing of the spreading code of the BeiDou satellite is enabled.

Similarly, when the signal capturing tool 101-1 serves as the master, whereas the signal capturing tools 101-2 to 101-4 are set as slaves, it is made possible to process the spreading code of the Galileo satellite of which the number of points is four times that of the GPS satellite. Note that, as a matter of course, the control unit 121-1 of the signal capturing tool 101-1 outputs the spreading code with 4096 points for the Galileo from the spreading code unit 125-1 in this case.

According to the configuration as described above, it is made possible to receive the plurality of satellite signals having code lengths of the spreading codes different from one another.

<Function Implemented by Synchronous Addition Unit>

Next, a function implemented by the synchronous addition unit 123 will be described with reference to FIG. 3.

In detail, as illustrated in the top of FIG. 3, the synchronous addition unit 123 is configured to have such a function disposed with an adding unit 123a in addition to the memory 141 for 1024 points. Here, the adding unit 123a does not exist as an actual condition but formally represents the operation of the memory 141. That is, as illustrated in the bottom of FIG. 3, the memory 141 of the synchronous addition unit 123 sequentially accumulates respective signals of the I channel and the Q channel constituted by the spreading code from the top by an amount equivalent to 1024 points corresponding to the spreading code length (an amount of data equivalent to one millisecond in the GPS: width L in FIG. 3) and, when the accumulation of an amount equivalent to 1024 points is completed, the data is added again so as to be accumulated from the top.

At this time, because the memory 141 of the synchronous addition unit 123 does not recognize a top position of the spreading code, once an amount equivalent to the spreading code is accumulated, the memory 141 adds data at the same position again from the top position to accumulate, thereby adding the sequentially transmitted spreading codes to store while keeping the synchronization.

According to such processing, a signal forming the spreading code is repeatedly added and, as a consequence, it is made possible to improve the SN ratio of the spreading code.

<Function of Frequency Domain Correlation Unit>

Next, a function implemented by the frequency domain correlation unit 124 will be described with reference to FIG. 4. In detail, as illustrated in FIG. 4, the frequency domain correlation unit 124 is configured to have a configuration including 1024 first Fourier transform (FFT) calculation units 161a-1 and 161a-2, the memories 173 and 174, a complex conjugate calculation unit (conjugate) 161c, a complex conjugate multiplication unit 161b, and a 1024 inverse first Fourier transform (IFFT) calculation unit 161d.

Both of the 1024 first Fourier transform (FFT) calculation units 161a-1 and 161a-2 have the same function and that function is implemented by means of the calculation by the radix-4 calculation unit 171 and the radix-2 calculation unit 172 in such a manner that the I channel and the Q channel of the input spreading code are individually stored to the memories 173 and 174 after the FFT is applied thereto.

The complex conjugate calculation unit 161c takes a complex conjugate of a signal stored in the memory 174, which signal is obtained by applying the FFT to the spreading code supplied from the spreading code unit 125, and then supplies the obtained complex conjugate to the complex conjugate multiplication unit 161b.

The complex conjugate multiplication unit 161b carries out complex conjugate multiplication on the signal supplied from the complex conjugate calculation unit 161c and the spreading code from the satellite signal stored in the memories 173 and 174 after the FFT is applied thereto, to output to the 1024 IFFT calculation unit 161d.

The 1024 IFFT calculation unit 161d, of which the function is implemented by means of the calculation by the radix-4 calculation unit 171 and the radix-2 calculation unit 172, applies the IFFT (inverse FFT) to the I channel and the Q channel of the input signal individually to store to the memories 173 and 174 as frequency domain correlations.

The memories 173 and 174 individually output the frequency domain correlations of the I channel and the Q channel that have been stored.

<Function of Absolute-Value Adding Unit>

Next, a function implemented by the absolute-value adding unit 126 will be described with reference to FIG. 5.

As illustrated in the top of FIG. 5, the absolute-value adding unit 126 is made up of an absolute-value converter 126a, an adding unit 126b, and the memory 191. The absolute-value converter 126a converts the signals of the I channel and the Q channel representing the frequency domain correlations, which have been supplied from the frequency domain correlation unit 124, into absolute values to output to the adding unit 126b.

The adding unit 126b sequentially stores values converted into the absolute values to the memory 191 from the top position (address number 1) and, when the storing is finished until the end position (address number X: in the case of GPS, X=1024), processing of storing by addition is repeated from the top. As a result, as illustrated in the bottom of FIG. 5, the number of times of addition for the signals stored in the memory 191 increases starting from the first time of addition and, for example, when a peak serving as the top position of the spreading code appears at the N-th time of addition, the top position of the spreading code can be detected consequently.

According to the processing as described above, the SN ratio of the signal is improved and compared while the spreading code is received and at the same time, it is made possible to specify the top position.

Note that, although the above description has dealt with an example of using the correlation in the frequency domain, the correlation in the time domain may be employed to be used. However, because the fundamental processing is similar, the description thereof will be omitted.

<Signal Capturing Processing>

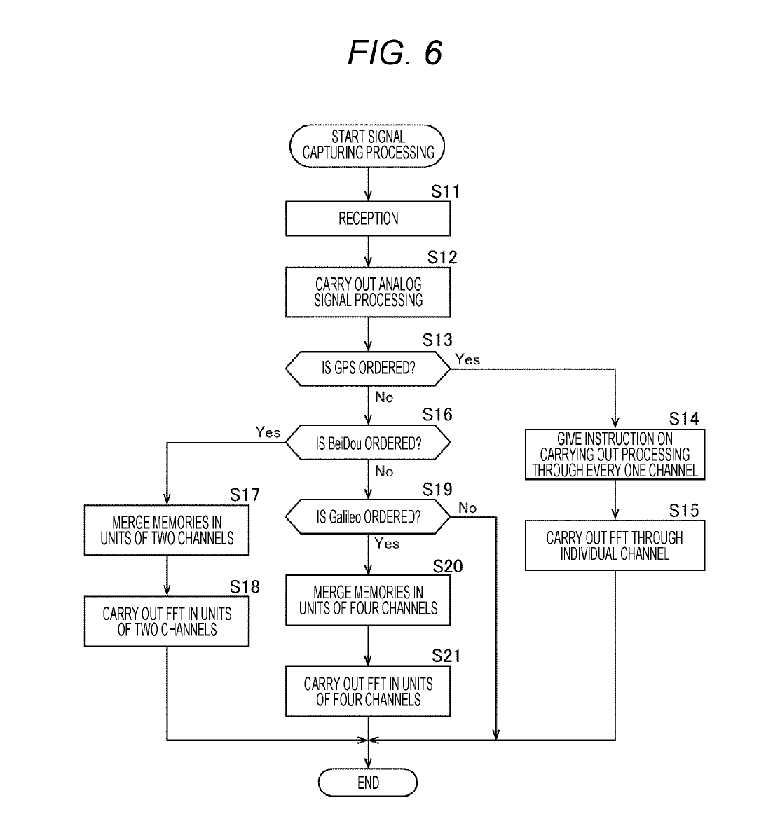

Next, signal capturing processing by the signal capturing unit 32 in FIG. 2 will be described with reference to the flowchart in FIG. 6.

In step S11, the antenna 12 receives a radio wave from a satellite (not illustrated) to output to the analog processing unit 21.

In step S12, the analog processing unit 21 converts the satellite signal received via the antenna 12 into the digital signal to supply to the digital processing unit 22. Describing in more detail, the analog processing unit 21 controls the analog front-end 51 (FIG. 2) to down-convert the radio frequency (RF) signal received via the antenna 12 into the intermediate frequency (IF). The analog processing unit 21 further controls the frequency converter 52 to carry out the analog-digital (AD) conversion on the satellite signal constituted by the analog signal, thereby converting the IF signal constituted by the analog signal to the baseband to sample, while quantizing the IF signal to output as the digital signal.

In step S13, the control unit 121 determines whether the instruction on the reception of the satellite signal corresponding to the GPS satellite has been given. For example, the assignment on which one of the signal capturing tools 101-1 to 101-n receives which one of the satellite signals from the GPS satellite, the BeiDou satellite, and the Galileo satellite may be set in advance by the control unit 31. For example, when the instruction on the reception of the satellite signal from the GPS satellite has been given, the processing proceeds to step S14.

In step S14, the control unit 121 switches the operation to a mode that causes each of the signal capturing tools 101 to receive the satellite signal from the GPS satellite alone (through one channel). Describing in more detail, the control unit 121 does not give an instruction for cooperatively using the memories 141, 173, 174, and 191 and the radix-4 calculation unit 171 to the control units 121 of the other signal capturing tools 101 but switches the operation to the mode of receiving the satellite signal from the GPS satellite by itself.

In step S15, the signal capturing tool 101 corresponding to one channel carries out the reception processing for the satellite signal from the GPS satellite by itself. Specifically, the Doppler correction unit 122 corrects frequency variations due to the Doppler effect and then supplies the satellite signal to the synchronous addition unit 123. As previously described with reference to FIG. 3, the synchronous addition unit 123 synchronously adds the satellite signal of which the frequency variations due to the Doppler effect have been corrected by the Doppler correction unit 122, by using the memory 141 to output to the frequency domain correlation unit 124.

The frequency domain correlation unit 124 calculates a correlation between the unique spreading code for the GPS satellite by the signal capturing unit 32 of its own, which has been output from the spreading code unit 125, and the spreading code of the transmitted satellite signal. More specifically, as previously described with reference to FIG. 4, the frequency domain correlation unit 124 controls the radix-4 calculation unit 171 to cause the radix-4 calculation unit 171 to carry out the 1024-point FFT processing and IFFT processing by using the memories 173 and 174 and then converts information on the received satellite signal in the time domain into information thereon in the frequency domain to obtain information on delay time having a highest correlation. Thereafter, the obtained information is output to the absolute-value adding unit 126.

As previously described with reference to FIG. 5, the absolute-value adding unit 126 adds the calculation result from the frequency domain correlation unit 124 by using the memory 191 to output.

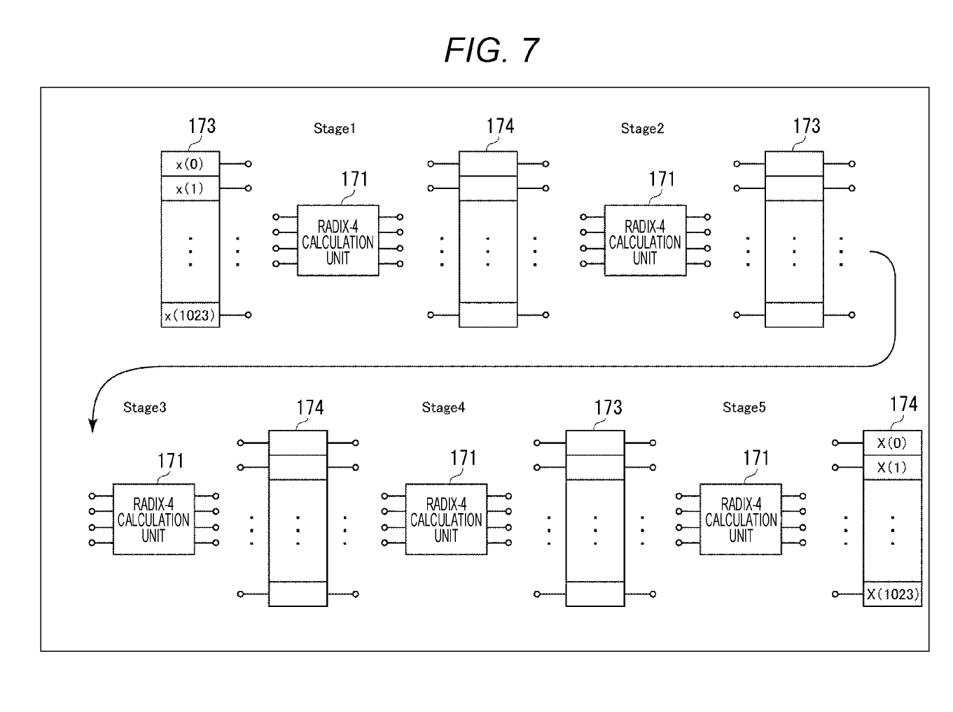

Describing in more detail, as illustrated in FIG. 7, the radix-4 calculation unit 171 works out data of 1024 points in the frequency domain denoted by X(0) to X(1024) from data of 1024 points in the time domain denoted by x(0) to x(1024), which data is stored in the memory 173, through processing of stages (Stages) 1 to 5 to output.

Here, the calculation carried out by the radix-4 calculation unit 171 is FFT calculation processing by way of so-called radix-4 butterfly calculation illustrated in FIG. 8. FIG. 8 illustrates calculation in which input values f(0) to f(3) are transformed to output values F(0) to F(3) through FFT processing by way of the radix-4 butterfly calculation indicated by frame F1. As illustrated in FIG. 8, the radix-4 butterfly calculation indicated by frame F1 is obtained by collecting four sets of radix-2 butterfly calculation indicated by frame F2.

That is, when the radix-4 butterfly calculation on 1024 points is carried out five times by the radix-4 calculation unit 171 as indicated in stages 1 to 5, it is made possible to carry out the FFT calculation corresponding to the number spreading code for the GPS satellite signal, namely, 4×4×4×4×4=1024 points. Note that IFFT calculation is implemented by carrying out the calculation previously described with reference to FIG. 7 in a direction opposite thereto, namely, in the order from stages 5 to 1. In addition, W in FIG. 8 (a subscript and a superscript are omitted to be given here) is defined as e^{-j2×π×(X/N)}, where the subscript thereof is assumed as N and the superscript thereof is assumed as X. Here, e represents a base of natural logarithm and (−j2×n×(X/N)) serves as an index thereof. Accordingly, W (the subscript and the superscript are omitted to be given here) is obtained as 1 in the case of X=0 and N=4 and obtained as −j in the case of X=1 and N=4.

On the other hand, when the instruction on the reception of the satellite signal from the GPS satellite is not given in step S13, the processing proceeds to step S16.

In step S16, the control unit 121 determines whether the instruction on the reception of the satellite signal corresponding to the BeiDou satellite has been given. To give an example, when one of the signal capturing tools 101-1 to 101-n has been instructed to receive the satellite signal from, for example, the BeiDou satellite, the processing proceeds to step S17.

In step S17, the control unit 121 switches the operation to a mode that causes every two signal capturing tools 101 to receive the satellite signal from the BeiDou satellite (through two channels). Describing in more detail, for example, the control unit 121-1 gives an instruction for cooperatively using the memories 141-2, 173-2, 174-2, and 191-2 to the control unit 121-2 of the signal capturing tool 101-2. Likewise, for example, the control unit 121-3 gives an instruction for cooperatively using the memories 141-4, 173-4, 174-4, and 191-4 to the control unit 121-4 of the signal capturing tool 101-4.

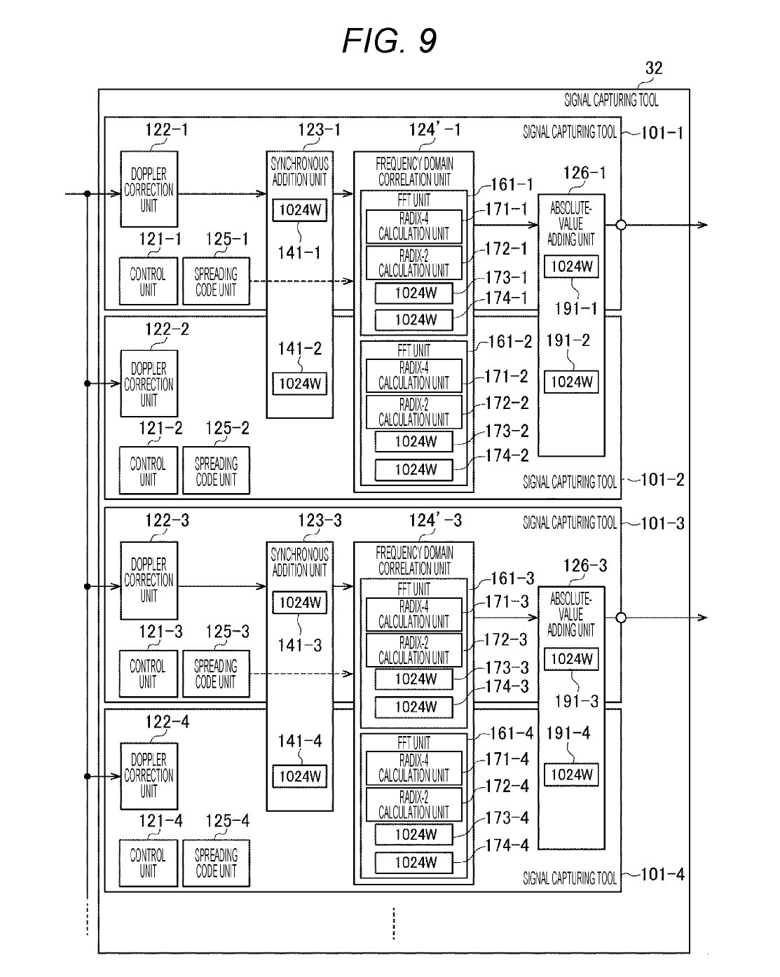

Accordingly, as illustrated in FIG. 9 as an example, the control unit 121-1 of the signal capturing tool 101-1 declares itself as the master and instructs the control unit 121-2 of the signal capturing tool 101-2 to serve as the slave. Similarly, the control unit 121-3 of the signal capturing tool 101-3 declares itself as the master and instructs the control unit 121-4 of the signal capturing tool 101-4 to serve as the slave.

At this time, the control unit 121-2 of the signal capturing tool 101-2 serves as the slave of the signal capturing tool 101-1 and thus, stops the operation of the Doppler correction unit 122-2, the synchronous addition unit 123-2, the frequency domain correlation unit 124-2, the spreading code unit 125-2, and the absolute-value adding unit 126-2.

In accordance with this, an arrow from each of the Doppler correction unit 122-2, the synchronous addition unit 123-2, the frequency domain correlation unit 124-2, the spreading code unit 125-2, and the absolute-value adding unit 126-2 is not displayed in FIG. 9, which indicates that no data is output therefrom because the operation thereof is stopped.

Similarly, the control unit 121-4 of the signal capturing tool 101-4 serves as the slave of the signal capturing tool 101-3 and thus, stops the operation of each of the Doppler correction unit 122-4, the synchronous addition unit 123-4, the frequency domain correlation unit 124-4, the spreading code unit 125-4, and the absolute-value adding unit 126-4.

In accordance with this, an arrow from each of the Doppler correction unit 122-4, the synchronous addition unit 123-4, the frequency domain correlation unit 124-4, the spreading code unit 125-4, and the absolute-value adding unit 126-4 is not displayed in FIG. 9, which indicates that no data is output therefrom because the operation thereof is stopped.

Furthermore, the control unit 121-2 controls the memory 141-2 to put under the control of the synchronous addition unit 123-1 of the signal capturing tool 101-1. The control unit 121-2 also controls such that the FFT unit 161-2 is put under the control of the frequency domain correlation unit 124-1. Additionally, the control unit 121-2 controls such that the memory 191-2 is put under the control of the absolute-value adding unit 126-1.

In order to indicate this state, the memory 141-2 is depicted as included in the synchronous addition unit 123-1 in FIG. 9. Likewise, in order to indicate that the FFT unit 161-2 is under the control of the frequency domain correlation unit 124-1, the FFT unit 161-2 is depicted as included in a corresponding frequency domain correlation unit 124′-1. Similarly, FIG. 9 depicts that the memory 191-2 is included in the absolute-value adding unit 126-1.

Similarly, the control unit 121-4 controls such that the memory 141-4 is put under the control of the synchronous addition unit 123-3 of the signal capturing tool 101-3. The control unit 121-4 also controls such that the memories 173-4 and 174-4 and the radix-4 calculation unit 171-4 are put under the control of the frequency domain correlation unit 124-3. Furthermore, the control unit 121-4 controls such that the memory 191-4 is put under the control of the absolute-value adding unit 126-3. FIG. 9 depicts that the memory 141-4 is included in the synchronous addition unit 123-3. Likewise, in order to indicate that the FFT unit 161-4 is under the control of the frequency domain correlation unit 124-3, the FFT unit 161-4 is depicted as included in a corresponding frequency domain correlation unit 124′-3. Similarly, FIG. 9 depicts that the memory 191-4 is included in the absolute-value adding unit 126-3.

Meanwhile, as indicated by a dotted line arrow in FIG. 9, the control unit 121-1 of the signal capturing tool 101-1 controls the spreading code unit 125-1 to cause the spreading code unit 125-1 to output its own unique spreading code with 2048 points for the BeiDou satellite. Similarly, as indicated by another dotted line arrow in FIG. 9, the control unit 121-3 of the signal capturing tool 101-3 controls the spreading code unit 125-3 to cause the spreading code unit 125-3 to output its own unique spreading code with 2048 points for the BeiDou satellite.

With this, the synchronous addition unit 123-1 of the signal capturing tool 101-1 reserves a storage area for 2048 points constituted by the memories 141-1 and 141-2, thereby being able to process the spreading code of the BeiDou satellite by an amount equivalent to one period (an amount equivalent to two milliseconds). Meanwhile, the frequency domain correlation unit 124′-1 reserves two storage areas each for 2048 points by using the memories 173-1, 173-2, 174-1, and 174-2, thereby being able to process the spreading code of the BeiDou satellite by an amount equivalent to one period (an amount equivalent to two milliseconds). In addition, when using the radix-4 calculation units 171-1 and 171-2 for 1024 points and the radix-2 calculation unit 172-1 for 2048 points, the frequency domain correlation unit 124′-1 can process the spreading code of the BeiDou satellite with 2048 points by an amount equivalent to one period (an amount equivalent to two milliseconds). Furthermore, the absolute-value adding unit 126-1 reserves a storage area for 2048 points constituted by the memories 191-1 and 191-2, thereby being able to process the spreading code of the BeiDou satellite by an amount equivalent to one period (an amount equivalent to two milliseconds).

Similarly, it is also made possible for the signal capturing tool 101-3 to process the spreading code of the BeiDou satellite with 2048 points.

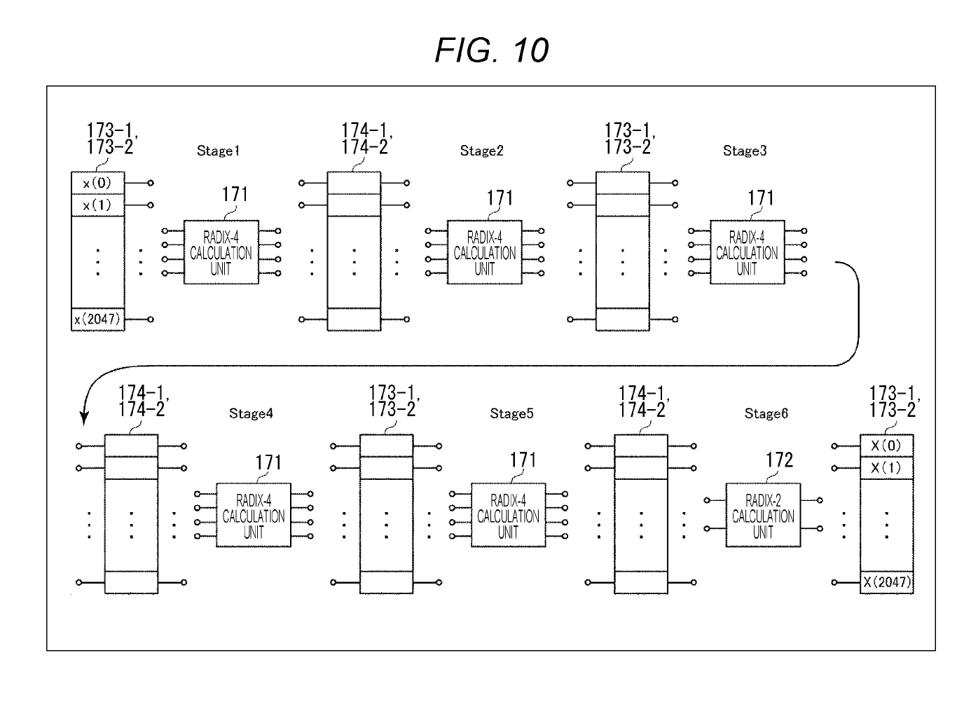

In this case, as illustrated in FIG. 10, the radix-4 calculation unit 171 for 2048 points, if present, carries out processing of stages (Stages) 1 to 5 and subsequently, the radix-2 calculation unit 172 carries out processing of stage (Stage) 6. Consequently, data of 2048 points in the frequency domain denoted by X(0) to X(2047) is worked out from data of 2048 points in the time domain denoted by x(0) to x(2047), which data is stored in the memory 173, to be output.

That is, when the radix-4 butterfly calculation on 2048 points is carried out five times by the radix-4 calculation unit 171 and the radix-2 butterfly calculation on 2048 points is carried out one time by the radix-2 calculation unit 172, it is made possible to carry out the FFT calculation processing corresponding to the number of points of the spreading code for the BeiDou satellite signal, namely, 4×4×4×4×4×2=2048 points.

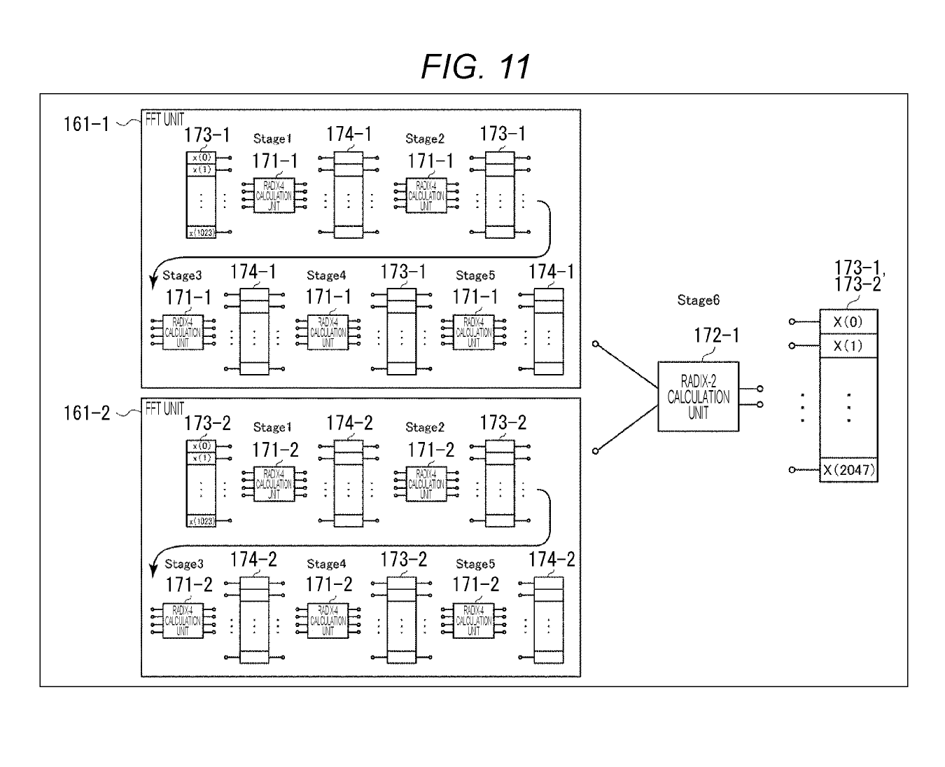

However, the radix-4 calculation unit 171 is configured to carry out the radix-4 butterfly calculation corresponding to 1024 points. Therefore, as illustrated in FIG. 11, by using the calculation results obtained through the processing of stages 1 to 5 by the radix-4 calculation units 171-1 and 171-2 of the FFT units 161-1 and 161-2, respectively, compatible with 1024 points, it is made possible for the radix-2 calculation unit 172-1 for 2048 points to calculate a correlation corresponding to the number of points of the spreading code for the BeiDou satellite signal with 2048 points in stage 6.

Consequently, it is made possible for each of the signal capturing tools 101-1 and 101-3 to use a storage capacity equal to two times that used during the processing of the spreading code of the GPS satellite as well as the radix-4 calculation units 171 for two times the number of points and the radix-2 calculation unit 172 for two times the number of points, whereby the processing of the spreading code of the BeiDou satellite is enabled.

Note that, in addition to this, for example, the radix-4 FFT calculation processing for 2048 points may be carried out through two times of processing by the radix-4 calculation unit 171-1 for 1024 points, or alternatively, the FFT calculation processing for 2048 points may be carried out by two radix-2 calculation units 172-1 and 172-2 for 1024 points. Meanwhile, the IFFT calculation is implemented by carrying out the calculation in the order from the stages 6 to 1 in FIG. 10.

Furthermore, when the instruction on the reception of the satellite signal from the BeiDou satellite has not been given in step S16, the processing proceeds to step S19.

In step S19, the control unit 121 determines whether the instruction on the reception of the satellite signal corresponding to the Galileo satellite has been given. To give an example, when one of the signal capturing tools 101-1 to 101-n has been instructed to receive the satellite signal from, for example, the Galileo satellite, the processing proceeds to step S20. When the instruction on the reception of the satellite signal from the Galileo satellite has not been given, the processing is terminated since no instruction on the reception of any satellite signal has been given.

In step S20, the control unit 121 switches the operation to a mode that causes every four signal capturing tools 101 to receive the satellite signal from the Galileo satellite (through four channels). Describing in more detail, for example, the control unit 121-1 gives an instruction for cooperatively using the memories 141, 173, 174, and 191 to the control unit 121-2 to 121-4 of the signal capturing tools 101-2 to 101-4.

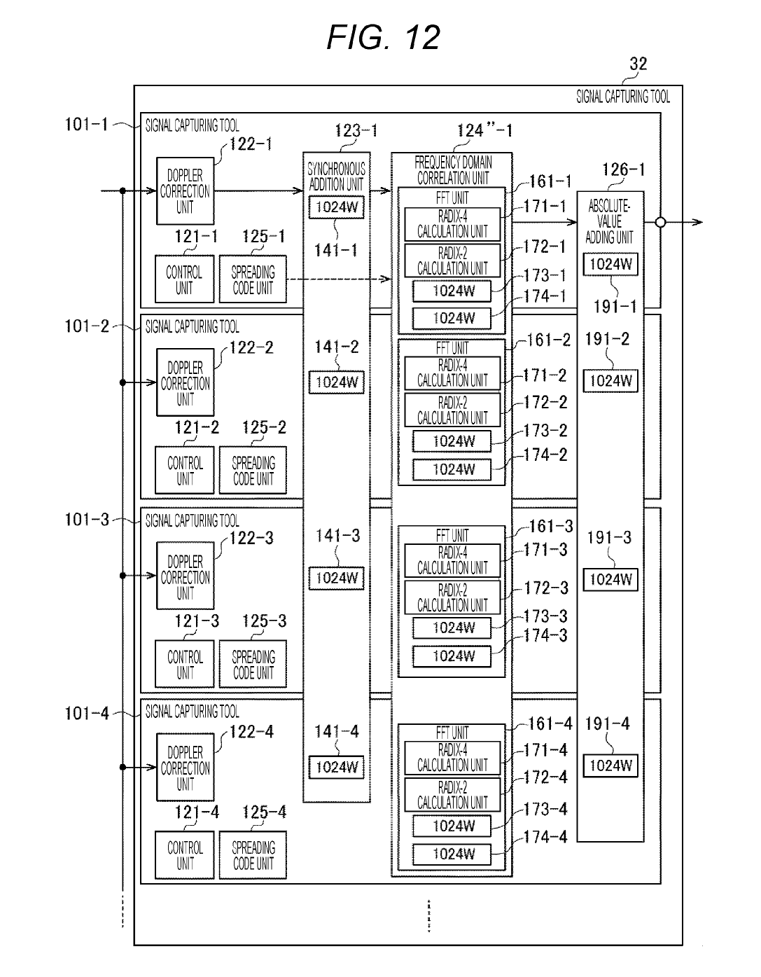

Accordingly, as illustrated in FIG. 12 as an example, the control unit 121-1 of the signal capturing tool 101-1 declares itself as the master and instructs the control units 121-2 to 121-4 of the signal capturing tools 101-2 to 101-4 to serve as the slaves.

At this time, the control units 121-2 to 121-4 of the signal capturing tools 101-2 to 101-4 serve as the slaves of the signal capturing tool 101-1 and thus, stop the operation of the Doppler correction units 122-2 to 122-4, the synchronous addition units 123-2 to 123-4, the frequency domain correlation units 124-2 to 124-4, the spreading code units 125-2 to 125-4, and the absolute-value adding units 126-2 to 126-4, respectively.

In accordance with this, an arrow from each of the Doppler correction units 122-2 to 122-4, the synchronous addition units 123-2 to 123-4, the frequency domain correlation units 124-2 to 124-4, the spreading code units 125-2 to 125-4, and the absolute-value adding units 126-2 to 126-4 is not displayed in FIG. 12, which indicates that no data is output therefrom because the operation thereof is stopped.

Furthermore, the control units 121-2 to 121-4 control such that the memories 141-2 to 141-4 are put under the control of the synchronous addition unit 123-1 of the signal capturing tool 101-1, respectively. The control units 121-2 to 121-4 also control such that the FFT units 161-2 to 161-4 are put under the control of the frequency domain correlation unit 124-1, respectively. Additionally, the control units 121-2 to 121-4 control such that the memories 191-2 to 191-4 are put under the control of the absolute-value adding unit 126-1, respectively.

In order to indicate this state, the memories 141-2 to 141-4 are depicted as included in the synchronous addition unit 123-1 in FIG. 12. Likewise, in order to indicate that the FFT units 161-2 to 161-4 are under the control of the frequency domain correlation unit 124-1, the FFT units 161-2 to 161-4 are depicted as included in a corresponding frequency domain correlation unit 124″-1.

In addition, as indicated by a dotted line in FIG. 12, the control unit 121-1 of the signal capturing tool 101-1 controls the spreading code unit 125-1 to cause the spreading code unit 125-1 to output the spreading code with 4096 points for the Galileo satellite.

With this, the synchronous addition unit 123-1 of the signal capturing tool 101-1 reserves a storage area for 4096 points constituted by the memories 141-1 to 141-4, thereby being able to process the spreading code of the Galileo satellite by an amount equivalent to one period (an amount equivalent to four milliseconds). Meanwhile, the frequency domain correlation unit 124″-1 reserves two storage areas each for 4096 points by using the memories 173-1 to 173-4 and 174-1 to 174-4, thereby being able to process the spreading code of the Galileo satellite by an amount equivalent to one period (an amount equivalent to four milliseconds). In addition, when using the radix-4 calculation units 171-1 to 171-4 for 1024 points, the frequency domain correlation unit 124″-1 can process the spreading code of the Galileo satellite with 4096 points by an amount equivalent to one period (an amount equivalent to four milliseconds). Furthermore, the absolute-value adding unit 126-1 reserves a storage area for 4096 points constituted by the memories 191-1 to 191-4, thereby being able to process the spreading code of the Galileo satellite by an amount equivalent to one period (an amount equivalent to four milliseconds).

Consequently, it is made possible for the signal capturing tool 101-1 to use a storage capacity equal to four times that used during the processing of the spreading code of the GPS satellite as well as the radix-4 calculation units 171 for four times the number of points, whereby the processing of the spreading code of the Galileo satellite is enabled.

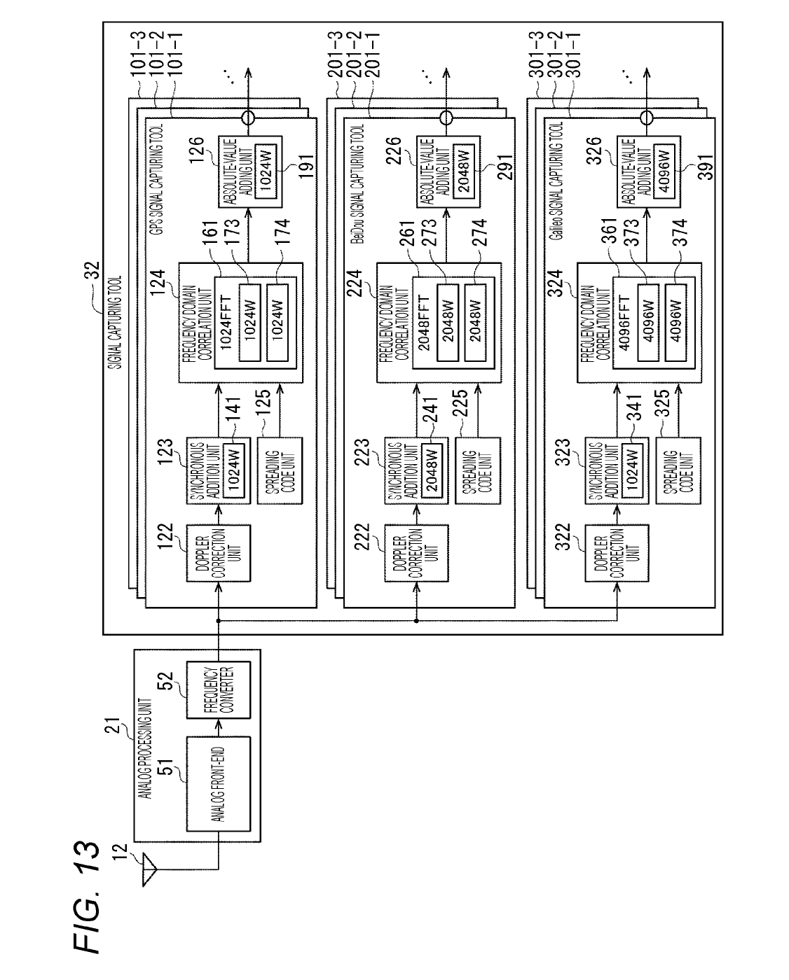

As described hitherto, in order to implement the processing corresponding to the respective spreading codes of the GPS satellite with 1024 points, the BeiDou satellite with 2048 points, and the Galileo satellite with 4096 points, as illustrated in FIG. 13 as an example, GPS signal capturing tools 101-1 to 101-n, BeiDou signal capturing tools 201-1 to 201-n, and Galileo signal capturing tools 301-1 to 301-n dedicated to the GPS satellite, the BeiDou satellite, and the Galileo satellite, respectively, have been required so far.

Note that, in FIG. 13, the GPS signal capturing tools 101-1 to 101-n, the BeiDou signal capturing tools 201-1 to 201-n, and the Galileo signal capturing tools 301-1 to 301-n are disposed independently within the signal capturing unit 32.

In addition, the BeiDou signal capturing tool 201 includes a Doppler correction unit 222, a synchronous addition unit (including a memory 241 for 2048 points) 223, a frequency domain correlation unit (including an FFT unit 261 including memories 273 and 274 each for 2048 points) 224, a spreading code unit 225, and an absolute-value adding unit (including a memory 291 for 2048 points) 226 for a dedicated use.

Furthermore, the Galileo signal capturing tool 301 includes a Doppler correction unit 322, a synchronous addition unit (including a memory 341 for 4096 points) 323, a frequency domain correlation unit (including an FFT unit 361 including memories 373 and 374 each for 4096 points) 324, a spreading code unit 325, and an absolute-value adding unit (including a memory 391 for 4096 points) 326 for a dedicated use.

For this reason, the apparatus cost has increased due to the configurations separately disposed and additionally, there has been a possibility of an increase in size of apparatus.

In contrast to this, in principle, because the signal capturing unit 32 according to the present technology illustrated in FIG. 2 has a configuration disposed with the signal capturing tools 101 compatible with the GPS satellite as a plurality of channels, the memories 141, 173, 174, and 191, the radix-4 calculation unit 171 for 1024 points, and the radix-2 calculation unit 172 for 2048 points are combined as necessary when used, whereby the implementation of the operation corresponding to each of the GPS satellite, the BeiDou satellite, and the Galileo satellite is enabled.

Consequently, while an increase in apparatus cost and an increase in size are suppressed, it is made possible to implement the capturing of signals from the plurality of satellites such as the GPS satellite, the BeiDou satellite, and the Galileo satellite.

Incidentally, variations for receiving the plurality of satellite signals can be disposed depending on how the signal capturing tools 101 are combined.

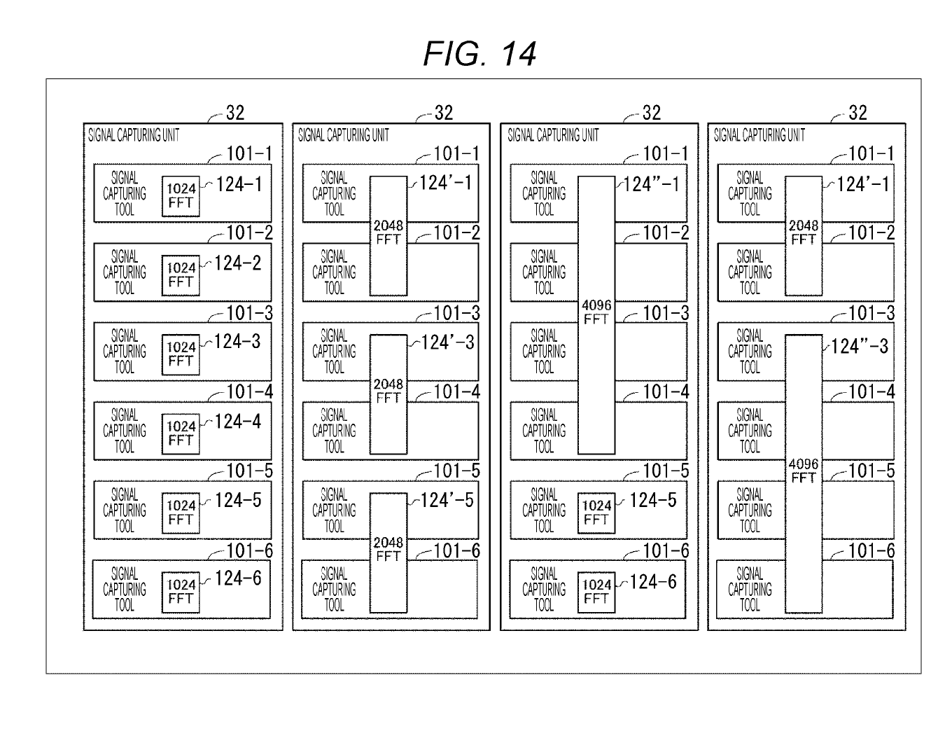

Specifically, when six signal capturing tools 101 are used (in the case of signal capturing tools 101-1 to 101-6) as illustrated in FIG. 14 as an example, the signal capturing tools 101-1 to 101-6 may be configured to implement frequency domain correlation units 124-1 to 124-6 compatible with the spreading code with 1024 points, respectively, such that signals from six types of the GPS satellites are received as illustrated in the leftmost part in FIG. 14. Meanwhile, as illustrated in the second column from the left in FIG. 14, respective pairs of the signal capturing tools 101-1 and 101-2, the signal capturing tools 101-3 and 101-4, and the signal capturing tools 101-5 and 101-6 may be combined to implement frequency domain correlation units 124′-1 to 124′-3 compatible with the spreading code with 2048 points, respectively, such that signals from three types of the BeiDou satellites are received. Additionally, as illustrated in the second column from the right in FIG. 14, the signal capturing tools 101-1 to 101-4 may be configured to implement a frequency domain correlation unit 124″-1 compatible with the spreading code with 4096 points such that a signal from the Galileo satellite is received, whereas the signal capturing tools 101-5 and 101-6 may be configured to implement the frequency domain correlation units 124-5 and 124-6 compatible with the spreading code with 1024 points, respectively, such that signals from the GPS satellite are received. Furthermore, as illustrated in the rightmost column in FIG. 14, the signal capturing tools 101-1 and 101-2 may be configured to implement a frequency domain correlation unit 124′-1 compatible with the spreading code with 2048 points such that a signal from the BeiDou satellite is received, whereas the signal capturing tools 101-3 to 101-6 may be configured to implement a frequency domain correlation unit 124″-3 compatible with the spreading code with 4096 points such that a signal from the Galileo satellite is received.

In addition to the above, various combinations may be employed to enable the reception of the plurality of satellite signals of the plurality of types.

Note that, although the above description has dealt with examples of the GPS satellite, the BeiDou satellite, and the Galileo satellite, it is also made possible to cope with a signal from a satellite other than these satellites similarly as long as the spreading code is constituted by a multiple of 1024 points. In addition, because similar processing can be carried out in accordance with multiples, the plurality of signal capturing tools 101 capable of, for example, the processing for 512 points may be prepared to be combined. Furthermore, even in the case of an extension code not constituted by a multiple of 1024 points, a configuration capable of the processing for the number of points equal to or greater than a required number of points is prepared by combination and, for example, an unnecessary point is processed by inputting zero or by another manner, whereby the satellite signal using an extension code with the number of points other than a multiple of 1024 points can be coped with.

Incidentally, a series of the above-described processing can be carried out by hardware but also can be carried out by software. When the series of the processing is carried out by software, a program constituting the software is installed from a recording medium to a computer built into dedicated hardware or a computer capable of executing various types of functions when installed with various types of programs, for example, a general-purpose computer.

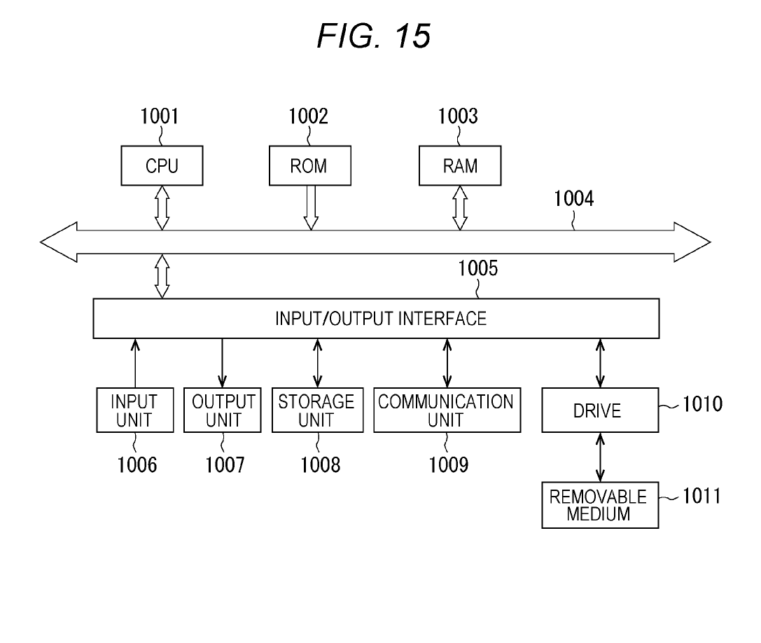

FIG. 15 illustrates a configuration example of a general-purpose personal computer. This personal computer includes a built-in central processing unit (CPU) 1001. An input/output interface 1005 is connected to the CPU 1001 via a bus 1004. A read only memory (ROM) 1002 and a random access memory (RAM) 1003 are connected to the bus 1004.

An input unit 1006 including an input device such as a keyboard and a mouse with which the user inputs an operation command, an output unit 1007 that outputs a processing operation screen and an image of a processing result to a display device, a storage unit 1008 including a hard disk drive that stores a program and various types of data, and a communication unit 1009 including a local area network (LAN) adapter to carry out communication processing via a network typified by the Internet are connected to the input/output interface 1005. Additionally, a magnetic disk (including a flexible disk), an optical disk (including a compact disc-read only memory (CD-ROM) and a digital versatile disc (DVD)), a magneto-optical disk (including a mini disc (MD)), or a drive 1010 that reads and writes data from and to a removable medium 1011 such as a semiconductor memory is connected thereto.

The CPU 1001 executes various types of processing in accordance with a program stored in the ROM 1002 or a program read from the removable medium 1011 such as a magnetic disk, an optical disk, a magneto-optical disk, or a semiconductor memory to be installed to the storage unit 1008 and then loaded to the RAM 1003 from the storage unit 1008. Meanwhile, data necessary for the CPU 1001 to execute various types of processing and so on is stored in the RAM 1003 as appropriate.

In the computer having the configuration as described above, for example, the aforementioned series of the processing is carried out in such a manner that the CPU 1001 loads a program stored in the storage unit 1008 to the RAM 1003 via the input/output interface 1005 and the bus 1004 to execute.

For example, the program executed by the computer (CPU 1001) can be provided by being recorded in the removable medium 1011 serving as a package medium or the like. In addition, the program can be provided via a wired or wireless transmission medium such as a local area network, the Internet, or digital satellite broadcasting.

In the computer, the program can be installed to the storage unit 1008 via the input/output interface 1005 by mounting the removable medium 1011 in the drive 1010. The program can be also installed to the storage unit 1008 via a wired or wireless transmission medium when received by the communication unit 1009. As an alternative manner, the program can be installed to the ROM 1002 or the storage unit 1008 in advance.

Note that, the program executed by the computer may be a program in which the processing is carried out along the time series in accordance with the order described in the present description, or alternatively, may be a program in which the processing is carried out in parallel or at a necessary timing, for example, when called.

Meanwhile, in the present description, the system refers to a collection of a plurality of constituent members (e.g., apparatuses and modules (components)) and whether all the constituent members are arranged within the same cabinet is not regarded as important. Therefore, a plurality of apparatuses accommodated in separate cabinets so as to be connected to one another via a network and one apparatus of which a plurality of modules is accommodated within one cabinet are both deemed as systems.

Note that the embodiments according to the present technology are not limited to the aforementioned embodiments and various modifications can be made without departing from the scope of the present technology.

For example, the present technology can employ a cloud computing configuration in which one function is divided and allocated to a plurality of apparatuses so as to be processed in coordination thereamong via a network.

In addition, the respective steps described in the aforementioned flowchart can be carried out by a plurality of apparatuses each taking a share thereof as well as carried out by a single apparatus.

Furthermore, when a plurality of processing tasks is included in one step, the plurality of processing tasks included in one step can be carried out by a plurality of apparatuses each taking a share thereof as well as carried out by a single apparatus.

Note that the present technology can be also configured as described below.

(1) A receiving apparatus for a global navigation satellite system, including:

a reception unit that receives a satellite signal;

a correlation calculation unit that calculates a correlation between the satellite signal and a pseudo signal through FFT calculation regarding the satellite signal received by the reception unit and the pseudo signal generated from a spreading code having a data length corresponding to a class of the satellite signal;

a memory for a predetermined data length required for the FFT calculation in the correlation calculation unit; and

a plurality of signal capturing tools that captures the satellite signal on the basis of the correlation calculated by the correlation calculation unit, in which

the correlation calculation unit of the predetermined signal capturing tool carries out the FFT calculation on the satellite signal and the pseudo signal generated from the spreading code having the data length corresponding to the class of the satellite signal by using the memory of its own and memories of other signal capturing tools in accordance with the class of the satellite signal and calculates the correlation between the satellite signal and the pseudo signal.

(2) The receiving apparatus for the global navigation satellite system according to (1), in which

the correlation calculation unit calculates the correlation between the satellite signal and the pseudo signal in a frequency domain or a time domain.

(3) The receiving apparatus for the global navigation satellite system according to (1), in which

the predetermined data length is 1024 words, and

when the class of the satellite signal is a satellite signal from a global positioning system (GPS) satellite, the correlation calculation unit carries out the FFT calculation on the satellite signal and the pseudo signal generated from the spreading code having the data length corresponding to the class of the satellite signal by using only the memory of its own and calculates the correlation between the satellite signal and the pseudo signal.

(4) The receiving apparatus for the global navigation satellite system according to (3), in which

the correlation calculation unit includes a radix-4 calculation unit that carries out radix-4 FFT calculation on 1024 words, and

the radix-4 calculation unit calculates the correlation between the satellite signal and the pseudo signal by repeatedly carrying out the radix-4 FFT calculation on 1024 words five times.

(5) The receiving apparatus for the global navigation satellite system according to (1), in which

the predetermined data length is 1024 words, and

when the class of the satellite signal is a satellite signal from a BeiDou navigation satellite system (BeiDou) satellite, the correlation calculation unit carries out the FFT calculation on the satellite signal and the pseudo signal generated from the spreading code having the data length according to the class of the satellite signal by using the memory of its own and a memory of one of the aforementioned other signal capturing tools and calculates the correlation between the satellite signal and the pseudo signal.

(6) The receiving apparatus for the global navigation satellite system according to (5), in which

the correlation calculation unit includes:

a radix-4 calculation unit that carries out radix-4 FFT calculation on 1024 words; and

a radix-2 calculation unit that carries out radix-2 FFT calculation on 2048 words, and

calculates the correlation between the satellite signal and the pseudo signal by causing each of the radix-4 calculation unit of its own and radix-4 calculation units of the aforementioned other signal capturing tools to repeat the radix-4 FFT calculation on 1024 words five times and thereafter, carrying out the radix-2 FFT calculation on 2048 words.

(7) The receiving apparatus for the global navigation satellite system according to (1), in which

the predetermined data length is 1024 words, and

when the class of the satellite signal is a satellite signal from a Galileo satellite, the correlation calculation unit carries out the FFT calculation on the satellite signal and the pseudo signal generated from the spreading code having the data length corresponding to the class of the satellite signal by using the memory of its own and memories of three of the aforementioned other signal capturing tools and calculates the correlation between the satellite signal and the pseudo signal.

(8) The receiving apparatus for the global navigation satellite system according to (1), in which

at least one of the following actions is carried out among the plurality of signal capturing tools:

one of the signal capturing tools captures the satellite signal from a global positioning system (GPS) satellite by itself;

any two of the signal capturing tools capture the satellite signal from a BeiDou navigation satellite system (BeiDou) satellite;

and

any four of the signal capturing tools capture the satellite signal from a Galileo satellite.

(9) A receiving method of a receiving apparatus for a global navigation satellite system, the receiving apparatus for the global navigation satellite system including:

a reception unit that receives a satellite signal;

a correlation calculation unit that calculates a correlation between the satellite signal and a pseudo signal through FFT calculation regarding the satellite signal received by the reception unit and the pseudo signal generated from a spreading code having a data length corresponding to a class of the satellite signal;

a memory for a predetermined data length required for the FFT calculation in the correlation calculation unit; and

a plurality of signal capturing tools that captures the satellite signal on the basis of the correlation calculated by the correlation calculation unit, in which

the correlation calculation unit of the predetermined signal capturing tool carries out the FFT calculation on the satellite signal and the pseudo signal generated from the spreading code having the data length corresponding to the class of the satellite signal by using the memory of its own and memories of other signal capturing tools in accordance with the class of the satellite signal and calculates the correlation between the satellite signal and the pseudo signal.

(10) A program configured to cause a computer that controls a receiving apparatus, the receiving apparatus including:

a reception unit that receives a satellite signal;

a correlation calculation unit that calculates a correlation between the satellite signal and a pseudo signal through FFT calculation regarding the satellite signal received by the reception unit and the pseudo signal generated from a spreading code having a data length corresponding to a class of the satellite signal;

a memory for a predetermined data length required for the FFT calculation in the correlation calculation unit; and

a plurality of signal capturing tools that captures the satellite signal on the basis of the correlation calculated by the correlation calculation unit, the program causing the computer to execute such that:

the correlation calculation unit of the predetermined signal capturing tool carries out the FFT calculation on the satellite signal and the pseudo signal generated from the spreading code having the data length corresponding to the class of the satellite signal by using the memory of its own and memories of other signal capturing tools in accordance with the class of the satellite signal and calculates the correlation between the satellite signal and the pseudo signal.

REFERENCE SIGNS LIST

| | |
|---|---|
| 11 | GNSS receiver |
| 21 | Analog processing unit |
| 22 | Digital processing unit |
| 31 | Control unit |
| 32 | Signal capturing unit |
| 33 | Signal tracking unit |
| 34 | Positioning unit |
| 101, 101-1 to 101-n | Signal capturing tool |
| 121, 121-1 to 121-n | Control unit |
| 122, 122-1 to 122-n | Doppler correction unit |
| 123, 123-1 to 123-n | Period addition unit |
| 124, 124-1 to 124-n, 124′, 124′-1 to | Frequency domain correlation |
| 124′-n, 124″, 124″-1 to 124″-n | unit |
| 125, 125-1 to 125-n | Spreading code |
| 126, 126-1 to 126-n | Absolute-value adding unit |
| 141, 141-1 to 141-n | Memory |
| 161, 161-1 to 161-n | FFT unit |
| 171, 171-1 to 171-n | Radix-4 calculation unit |
| 172, 172-1 to 172-n | Radix-2 calculation unit |
| 173, 173-1 to 173-n, 174, 174-1 to 174-n | Memory |
| 191, 191-1 to 191-n | Memory |

1. A receiving apparatus for a global navigation satellite system, comprising:
a reception unit that receives a satellite signal;
a correlation calculation unit that calculates a correlation between the satellite signal and a pseudo signal through FFT calculation regarding the satellite signal received by the reception unit and the pseudo signal generated from a spreading code having a data length corresponding to a class of the satellite signal;
a memory for a predetermined data length required for the FFT calculation in the correlation calculation unit; and
a plurality of signal capturing tools that captures the satellite signal on the basis of the correlation calculated by the correlation calculation unit, wherein
the correlation calculation unit of the predetermined signal capturing tool carries out the FFT calculation on the satellite signal and the pseudo signal generated from the spreading code having the data length corresponding to the class of the satellite signal by using the memory of its own and memories of other signal capturing tools in accordance with the class of the satellite signal and calculates the correlation between the satellite signal and the pseudo signal.

2. The receiving apparatus for the global navigation satellite system according to claim 1, wherein
the correlation calculation unit calculates the correlation between the satellite signal and the pseudo signal in a frequency domain or a time domain.

3. The receiving apparatus for the global navigation satellite system according to claim 1, wherein
the predetermined data length is 1024 words, and
when the class of the satellite signal is a satellite signal from a global positioning system (GPS) satellite, the correlation calculation unit carries out the FFT calculation on the satellite signal and the pseudo signal generated from the spreading code having the data length corresponding to the class of the satellite signal by using only the memory of its own and calculates the correlation between the satellite signal and the pseudo signal.

4. The receiving apparatus for the global navigation satellite system according to claim 3, wherein
the correlation calculation unit comprises a radix-4 calculation unit that carries out radix-4 FFT calculation on 1024 words, and
the radix-4 calculation unit calculates the correlation between the satellite signal and the pseudo signal by repeatedly carrying out the radix-4 FFT calculation on 1024 words five times.

5. The receiving apparatus for the global navigation satellite system according to claim 1, wherein
the predetermined data length is 1024 words, and
when the class of the satellite signal is a satellite signal from a BeiDou navigation satellite system (BeiDou) satellite, the correlation calculation unit carries out the FFT calculation on the satellite signal and the pseudo signal generated from the spreading code having the data length according to the class of the satellite signal by using the memory of its own and a memory of one of the aforementioned other signal capturing tools and calculates the correlation between the satellite signal and the pseudo signal.

6. The receiving apparatus for the global navigation satellite system according to claim 5, wherein
the correlation calculation unit comprises:
a radix-4 calculation unit that carries out radix-4 FFT calculation on 1024 words; and
a radix-2 calculation unit that carries out radix-2 FFT calculation on 2048 words, and
calculates the correlation between the satellite signal and the pseudo signal by causing each of the radix-4 calculation unit of its own and radix-4 calculation units of the aforementioned other signal capturing tools to repeat the radix-4 FFT calculation on 1024 words five times and thereafter, carrying out the radix-2 FFT calculation on 2048 words.

7. The receiving apparatus for the global navigation satellite system according to claim 1, wherein
the predetermined data length is 1024 words, and
when the class of the satellite signal is a satellite signal from a Galileo satellite, the correlation calculation unit carries out the FFT calculation on the satellite signal and the pseudo signal generated from the spreading code having the data length corresponding to the class of the satellite signal by using the memory of its own and memories of three of the aforementioned other signal capturing tools and calculates the correlation between the satellite signal and the pseudo signal.

8. The receiving apparatus for the global navigation satellite system according to claim 1, wherein
at least one of the following actions is carried out among the plurality of signal capturing tools:
one of the signal capturing tools captures the satellite signal from a global positioning system (GPS) satellite by itself;
any two of the signal capturing tools capture the satellite signal from a BeiDou navigation satellite system (BeiDou) satellite;
and
any four of the signal capturing tools capture the satellite signal from a Galileo satellite.

9. A receiving method of a receiving apparatus for a global navigation satellite system, the receiving apparatus for the global navigation satellite system comprising:
a reception unit that receives a satellite signal;
a correlation calculation unit that calculates a correlation between the satellite signal and a pseudo signal through FFT calculation regarding the satellite signal received by the reception unit and the pseudo signal generated from a spreading code having a data length corresponding to a class of the satellite signal;
a memory for a predetermined data length required for the FFT calculation in the correlation calculation unit; and
a plurality of signal capturing tools that captures the satellite signal on the basis of the correlation calculated by the correlation calculation unit, wherein
the correlation calculation unit of the predetermined signal capturing tool carries out the FFT calculation on the satellite signal and the pseudo signal generated from the spreading code having the data length corresponding to the class of the satellite signal by using the memory of its own and memories of other signal capturing tools in accordance with the class of the satellite signal and calculates the correlation between the satellite signal and the pseudo signal.

10. A program configured to cause a computer that controls a receiving apparatus, the receiving apparatus comprising:
a reception unit that receives a satellite signal;
a correlation calculation unit that calculates a correlation between the satellite signal and a pseudo signal through FFT calculation regarding the satellite signal received by the reception unit and the pseudo signal generated from a spreading code having a data length corresponding to a class of the satellite signal;
a memory for a predetermined data length required for the FFT calculation in the correlation calculation unit; and
a plurality of signal capturing tools that captures the satellite signal on the basis of the correlation calculated by the correlation calculation unit, the program causing the computer to execute such that:
the correlation calculation unit of the predetermined signal capturing tool carries out the FFT calculation on the satellite signal and the pseudo signal generated from the spreading code having the data length corresponding to the class of the satellite signal by using the memory of its own and memories of other signal capturing tools in accordance with the class of the satellite signal and calculates the correlation between the satellite signal and the pseudo signal.
